(19) United States
(12) Patent Application Publication
(10) Pub. No.: US 2014/0216357 A1
(43) Pub. Date: Aug. 7, 2014

(54) PIGMENT-FREE ELASTOMERIC PET TOY

(71) Applicant: Lawrence I. Wechsler, Great Neck, NY (US)

(72) Inventor: Lawrence I. Wechsler, Great Neck, NY (US)

(21) Appl. No.: 13/759,075

(22) Filed: Feb. 5, 2013

(51) Int. Cl. A01K 15/02

(52) U.S. Cl. CPC A01K 15/025
USPC 119/707

(57) ABSTRACT

A toy is formed at least partially of a composition in which pigment is intentionally substantially omitted, and a natural color of the unadulterated resin, after vulcanization or other curing procedure of natural and synthetic thermoset rubber types requiring cross-linking, is retained.

### CROSS REFERENCE TO RELATED APPLICATIONS

This application claims the benefit of U.S. Provisional Application No. 61/595,162 filed Feb. 6, 2012 entitled PIGMENT-FREE ELASTOMERIC PET TOY.

### BACKGROUND OF THE INVENTION

The present invention relates to a pet toy, and more particularly to a pet toy comprised of an elastomeric material, such as for example, natural rubber.

A vast amount of pet toys are available on the market, produced by a wide range of manufacturers. These include well known rubber toys, comprised of natural and man-made rubber, as well as synthetic thermoplastic resins. These have always, without exception, been colored with suitable pigments to give a rich color, for example, to increase consumer appeal. Many manufacturers also rely on unique signature colors to distinguish their brand from their competition.

A large percentage of these toys are produced in overseas factories, and without the stringent standards practiced, for example, in American facilities, there is the possibility that pigments used to impart color to these toys will potentially comprise harmful substances, such as heavy metals, toxins, etc.

Even if a particular pigment is generally accepted as not posing a health threat to an adult cat or dog through normal use of a toy, some pet owners may nevertheless prefer that additives to a particular rubber, excluding, for example, those necessary to properly carry out vulcanization in rubber compositions requiring such treatment, be absent from the toy. It is believed that consumer concerns will be even more prevalent among puppy and kitten owners, since at this stage of development, the pet is particularly sensitive to environmental influences, including exposure to various chemical substances.

Consequently, it would be highly desirable to provide an elastomeric pet toy comprising natural rubber that is substantially free of pigment and/or other additives, for example, fillers, such that a dog or cat owner could have greater peace of mind when supervising play with the toy.

### SUMMARY OF THE INVENTION

An object of the invention is therefore to provide a pet toy in which unnecessary additives, other than those essential for imparting specific mechanical characteristics, are substantially absent from the elastomeric composition from which the toy is formed. These unnecessary additives at least include a coloring agent, especially in the form of an inorganic pigment, which, in accordance with the invention, is intentionally substantially absent from a final pet toy composition. For purposes herein, the term “coloring agent” is defined as any additive which is primarily intended to impart color to a product, and includes, for example, dyes, pigments, etc.

This object is achieved, in accordance with an embodiment of the invention, by the provision of toy formed at least partially of a composition in which pigment is intentionally substantially omitted, and a natural color of the unadulterated resin, after vulcanization or other curing procedure, in the case of natural and synthetic thermoset rubber types requiring cross-linking, is retained. Such toy will be suitably configured for various modes of entertainment generally associated with rubber toys conventionally available, including for example, fetch play, chew, treat dispensing, dental cleaning, etc.

It is believed that omission of added pigment, and the concomitant resultant lack of artificial color imparted to the toy, an appearance characteristic which has conventionally been deemed essential to creation of a successful toy line by a manufacturer, will be offset by a buying public increasingly aware of environmental hazards and desirous of restricting exposure of their pet, particularly a young animal, such as a puppy or kitten, to unnecessary health risks.

In accordance with an advantageous embodiment of the invention, the composition used, at least in part, for the pet toy, comprises a relatively high grade natural rubber (isoprene) resin which, when cross-linked by suitable and well known vulcanization techniques, will retain a certain degree of transparency and a natural amber (yellow-brownish) color. This appearance unexpectedly provides a great degree of branding recognition for any style toy comprised of this material by a particular manufacturer, thereby offsetting any conventionally perceived commercial disadvantage encountered as a consequence of a lack a bright color which was heretofore added, and resulting from the intentional omission of added pigment.

A particularly advantageous embodiment is directed to a pet toy comprised of a natural rubber composition which is not only substantially free of dies or pigments, but which is also substantially devoid of filler, such a silica, carbon black, etc., which would otherwise impede the light transmissive quality (transparency or translucence) ordinarily present in unadulterated natural rubber.

In accordance with yet a further advantageous embodiment, the rubber used for the composition comprising the pet toy will be selected from a relatively higher (superior) grade of raw rubber, such that the final product will be substantially free of impurities, optical, and otherwise, be stronger, and have a better perceived and less intense smell than standard or lesser grades of rubber.

According to another embodiment, a rubber composition according to the embodiments disclosed herein, advantageously is comprised of a higher grade of rubber which exhibits a moderate degree of transparency, and is used to form a toy having an outer envelope of suitable shape and at least one interior space having an opening through which a treat, food, catnip, or the like can be inserted into the interior space. Consequently, the contents of the at least one interior space will be visible from outside the toy, through the walls defining the outer envelope. Such unique feature is not possible conventionally in natural rubber toys heretofore available, due to the presence of pigment(s) and/or fillers.

Pet toys produced according to other particularly advantageous embodiments of the invention, take the shape of items ordinarily associated with human infancy and early childhood, including familiar objects, such as, for example, building blocks, teething rings, pacifiers, teddy bears, etc.

It is contemplated within the scope of the invention, that a toy produced according to the invention can include other portions that contain substances other than the substantially pigment-free rubber composition described herein. For example, a molded toy body utilizing the special rubber composition can be used in conjunction with, for example, an attached or intertwined rope, bell, squeaker, etc.

The above, and other objects, features and advantages of the present invention will become apparent from the following description read in conjunction with the accompanying drawings.

### BRIEF DESCRIPTION OF THE DRAWINGS

FIG. 1 is bottom perspective view of an embodiment of a pet toy according to the invention;

FIG. 2 is a perspective view of an embodiment of a pet toy according to the invention which includes a combination of a rubber component and rope; and

FIG. 3 is a perspective view of another embodiment of a pet toy according to the invention which includes a combination of multiple rubber components and rope.

### DETAILED DESCRIPTION OF THE PREFERRED EMBODIMENT

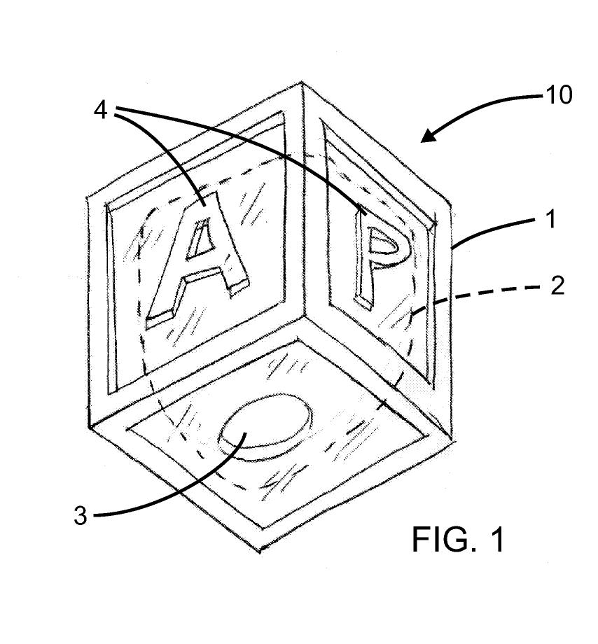

Referring to FIG. 1, a pet toy, generally designated 10, is comprised of a natural rubber composition containing natural rubber as a component, and which has been cured (cross-linked) by a suitable process, for example, vulcanization, to produce a body 1 of the pet toy 10. Pigments or other coloring agent components are intentionally substantially absent from the natural rubber composition. Further, according to an option of the invention, the composition employed in the depicted example, is also substantially free of filler of a type that would disadvantageously degrade transparency.

The body 1 of the pet toy 10, in the depicted example, is provided in a form resembling a child's building block, and includes an interior space 2 (the interior boundary of which is shown in broken line form) including an opening 3 through which treats/food/etc. can be inserted from the outside into the interior space 2, and held captive therein, for gradual consumption by the pet, as accessed thereby.

Various indicia can optionally be provided to enhance the impression of a building block, for example, in the form of embossed letters 4.

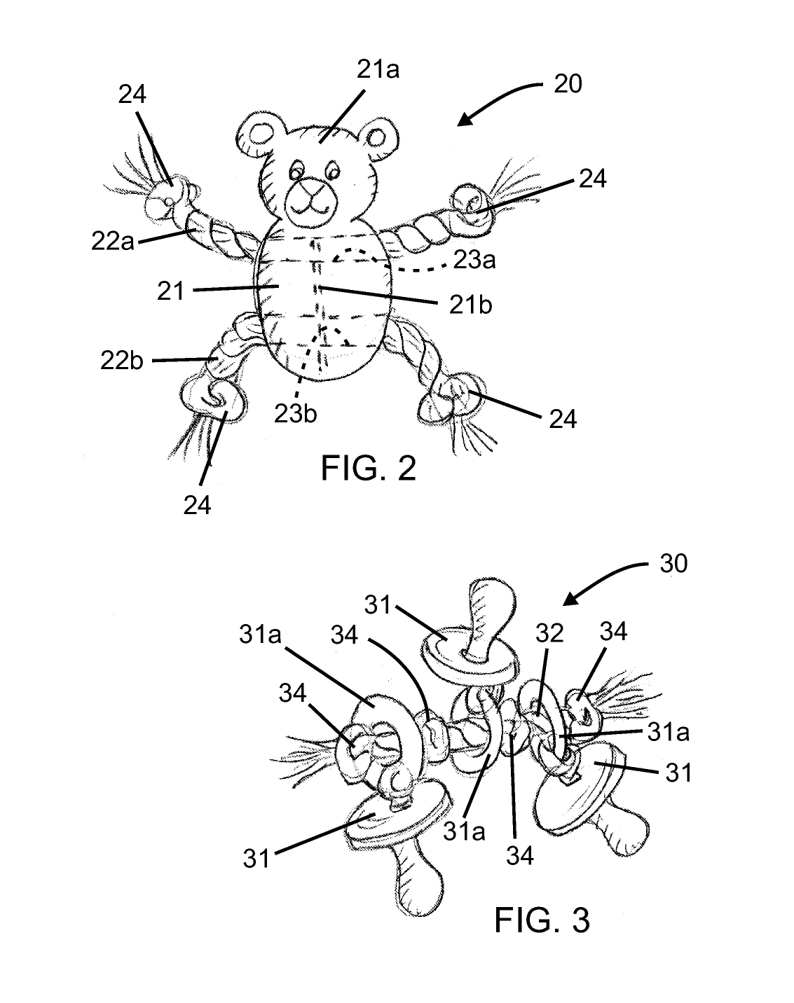

As mentioned above, pet toys produced according to other embodiments of the invention, advantageously take the shape of items ordinarily associated with human infancy and early childhood, including familiar objects, such as, for example, building blocks, teething rings, pacifiers, teddy bears, etc. Examples of these embodiments are depicted in FIGS. 2 and 3.

FIG. 2 depicts a toy 20 which takes the general form of a teddy bear. Toy 20 includes a body 21 comprised of the rubber composition according to the invention which is substantially free of at least a coloring agent. Body 21, which is conveniently molded as an integral part includes a head portion 21a and is textured with various surface features so as to resemble a stuffed teddy bear, including, for example, surface markings resembling a stitched seam 21b running down the front of body 21. A pair of ropes 22a, 22b are respectively passed through holes 23a, 23b formed in body 21 and include knots 24 at ends thereof, captively maintaining the ropes 22a, 22b to the body 21, which serve as arms and legs, respectively. Ropes 22a, 22b will advantageously be an eco-friendly, renewable material substantially free of dyes and other impurities, for example, white cotton.

Referring to FIG. 3, another toy is designated by the numeral 30. Toy 30 includes three toy bodies 31 comprised of substantially coloring agent-free elastomer produced in accordance with the invention. The toy bodies 31 each conveniently takes the form of a pacifier, each including a ring 31a through which a rope 32 is passed. Knots 34 tied between each of the toy bodies 31 and outside of outermost ones of the toy bodies 31 serve to separate the toy bodies from one another and maintain them captively to the rope 32.

In accordance with the invention, the rubber used to produce a suitably configured toy in which a coloring agent is intentionally absent is vulcanized by any suitable accepted technique routinely employed so as to result in crosslinking of the rubber polymer chains, as is readily known in the art. A suitable cure package can be employed to achieve the vulcanization, for example, including, but not limited to, a cure package which comprises a sulphur or peroxide based system, and which may further include accelerators, activators and/or antidegradants, according to common practice. A peroxide based cure package is believed to generally result in a vulcanized product which is lighter in color.

It is noted that since pet toys 10, 20, 30, and any other article made in accordance with embodiment of the invention, including other pet toys, will be lacking of color imparting pigment or other coloring agent, the use of a high grade rubber having a lighter yellow or amber color and low visible impurities and inclusions in its raw state prior to vulcanization, is deemed advantageous, though not essential to practice of the invention for the production thereof. For example, a rubber grade (high grade) deemed particularly advantageous for practice of the invention would be, for example, CV 50, CV 60, L or 3L (SVR), and more preferably be hand selected for the lightest and most visually appealing amber color (Lovibond scale color of 6 or less, and more preferably 4 or less).

It is further noted, that for applications in which a naturally occurring hardness of a product after vulcanization, believed to be a Shore A hardness of 30-35, is satisfactory, no reinforcing filler (e.g., silica) need be added to the natural rubber, and is, in fact, preferably omitted, so as to retain better clarity in the finished article. However, should the particular application call for reinforcement or hardening of the rubber (for example, where a Shore A hardness greater that 30-35 is desired), such as when a chew toy is intended for use with a dog known to be an aggressive chewer, use of a very high surface area silica, added in relatively small amounts as a strengthening/reinforcing filler, is deemed advantageous, as being thought to have the least dramatic effect of reducing clarity of the vulcanized rubber.

It is also noted, that while natural rubber is preferred in practice of the invention, due to its superior strength and durability characteristics to presently known synthetic thermosetting rubbers, such as, for example, styrene-butadiene rubber (SBR), the invention is intended to include the use of other thermoset resins in conjunction with, or entirely in place of natural rubber. New non-toxic thermoset resins still to be developed are also contemplated herein.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention.

1. A pet toy, comprising:
at least one elastomeric portion consisting of a non-toxic thermoset rubber composition, said composition being substantially free of added pigment, said at least one elastomeric portion being configured so as to be suitable for use in play by a pet.

2. A method of providing entertainment to a pet, comprising:
providing a pet toy including at least one body portion comprised of a natural rubber composition which is substantially free of any added coloring agent, thereby retaining the natural color of the natural rubber after curing; and
presenting the pet toy to the pet for play.

3. A pet toy according to claim 1, wherein said at least one elastomeric portion is configured to form at least a portion of an iconic shape associated with human infancy and early childhood.

4. A pet toy according to claim 1, further comprising at least one of rope, at least one bell or at least one squeaker.

5. A pet toy according to claim 1, wherein said thermoset rubber composition comprises a selected grade of rubber which exhibits a degree of transparency.

6. A pet toy according to claim 1, wherein said thermoset rubber composition is also substantially free of added dye or other coloring agent.

7. A method of entertaining a pet, comprising:
providing a pet toy, at least a portion of said pet toy including at least one elastomeric component or portion consisting of a thermoset rubber composition which is substantially free of added pigment; and
presenting the pet toy to the pet.

8. A method according to claim 7, wherein said thermoset rubber comprises natural rubber.

9. A method according to claim 7, wherein said thermoset rubber composition is also substantially free of added dye or other coloring agent.

10. A method according to claim 7, wherein said thermoset rubber composition comprises a selected grade of rubber which exhibits a degree of transparency.

11. A method according to claim 7, wherein said pet is a puppy.

12. A method according to claim 7, wherein said thermoset rubber composition is also substantially free of fillers.

13. A method according to claim 7, wherein said pet toy includes an iconic shape associated with human infancy and early childhood.

14. A method according to claim 7, wherein said pet toy further comprises at least one of rope, at least one bell or at least one squeaker.
